(19) United States
(12) Patent Application Publication
(10) Pub. No.: US 2012/0143539 A1
(43) Pub. Date: Jun. 7, 2012

(54) Energy Monitor

(76) Inventor: Damian Krause, New York, NY (US)

(21) Appl. No.: 12/958,796

(22) Filed: Dec. 2, 2010

(51) Int. Cl. G06F 19/00

(52) U.S. Cl. 702/62

(57) ABSTRACT

An energy monitor that measures the amount of electricity consumed by an appliance and translates that measurement into the amount of carbon dioxide that was emitted into the atmosphere as a result of creating that amount of electricity.

The present invention relates to a device that measures the amount of electricity consumed by an appliance and, based on the source of the electricity, calculates and displays the amount of carbon dioxide that was emitted into the atmosphere as a result of producing that amount of electricity.

### BACKGROUND OF THE INVENTION

Electricity is generated in many different ways, with a wide variation in environmental impact. When electricity is generated through the burning of fossil fuels such as oil, natural gas, or coal, carbon dioxide is released into the atmosphere. Carbon dioxide, along with methane, nitrous oxide, and fluorinated gases, are called “greenhouse gases” and are associated with a number of adverse environmental effects, including global warming, unhealthy air quality, and acid rain. These adverse effects are not associated with energy derived from solar, wind, or geothermal sources.

In view of the heightened awareness of the damage done to the environment as a result of the use of fossil fuels, the public has become more interested in the ways to reduce the emission of greenhouse gases. If people know the amount of destructive carbon that was emitted by the generation of the electricity needed to power their household appliances, they can make the decisions on which appliances to use, how often to use them, and whether to replace them with other appliances that have less of an adverse environmental impact.

There are a number of software programs that estimate a “carbon footprint,” i.e., the measure of the impact human activities have on the environment in terms of the amount of greenhouse gases produced, measured in units of carbon dioxide. See, e.g., www.carboncounter.org; www.carbonfootprint.com; and www.begreennow.com. These calculators factor in elements that characterize lifestyles, such as house size, type of car, miles traveled by air or road, to arrive at a number for a carbon footprint which depicts the relative impact on the environment such a lifestyle represents. These carbon footprints, while interesting, are merely approximations based on broad assumptions which may or may not hold true for any one individual or household.

Energy monitors for household appliances are known in the art. For example, U.S. Pat. No. 6,095,850 discloses an electric adapter that displays various parameters of the electricity consumed by an appliance that has been plugged into the adapter. Also, U.S. Pat. No. 6,476,729 discloses a power monitoring module with a display unit which is placed on a power strip to display the power used by the appliances plugged into the strip.

The prior art, however, does not reveal a device which can accurately indicate to a consumer, based on the source of electricity, how much carbon was emitted in the production of the electricity needed to run a particular appliance. Further, there is no disclosure of a device that can display the aggregate electricity consumption of multiple appliances.

### SUMMARY OF THE INVENTION

The present invention is directed to an energy monitor which can display various electrical parameters of one or more appliances. Included among the parameters that may be displayed is an accurate reading of the amount of carbon that was emitted by the generation of the electricity used by the appliances.

The energy monitor senses the amount of electricity that is drawn by an appliance and derives the number of watts being used by the appliance. A time base signal generator in the device measures the time during which the watts are being drawn to arrive at the number of kilowatt-hours used by the appliance. The number of kilowatt-hours are multiplied by the carbon dioxide emission rate for the specific power source from which the electricity is obtained to arrive at the weight of carbon dioxide that was released into the atmosphere by the generation of that amount of electricity.

Generating electricity from fossil fuels such as coal, petroleum, and gas results in the emission of carbon dioxide into the atmosphere, while electricity generated from nuclear, wind, geothermal, or solar sources does not. Power utility companies in different parts of the United States use different fuel mixes to obtain electricity to supply to its customers. The Environmental Protection Agency lists the percentages of the fuel mix components, i.e., “power profiles,” for different cities on its website, for example:

| | non-hydro | | | | | |
|---|---|---|---|---|---|---|
| | renewables | hydro | nuclear | oil | gas | coal |
| New York NY | 0.5 | 0 | 43.8 | 20.2 | 34.9 | 0 |
| Los Angeles CA | 9.4 | 17.7 | 16.5 | 1.2 | 42.3 | 11.9 |
| Washington DC | 1.2 | 0.9 | 38.3 | 4.0 | 9.6 | 45.1 |
| Dallas TX | 1.3 | 0.3 | 11.9 | 0.5 | 47.5 | 37.1 |
| Fairbanks AK | 0 | 11.7 | 0 | 7.1 | 69.4 | 11.8 |
| Miami FL | 1.5 | 0 | 13.8 | 17.9 | 39.0 | 26.2 |
| Chicago IL | 0.4 | 0.7 | 22.3 | 0.4 | 2.7 | 72.8 |
| Boise ID | 2.3 | 48.6 | 3.3 | 0.3 | 10.8 | 34.4 |
| National Avg | 2.1 | 6.5 | 19.3 | 3.0 | 18.8 | 49.6 |

Carbon dioxide emission rates are calculated based on power profiles from generating units of U.S. electric plants. The carbon emission rate, i.e., pounds of carbon dioxide per kilowatt-hour, in different geographic regions in 1999 have been calculated to be

| | |
|---|---|
| New England | 1.077 |
| Middle Atlantic | 1.058 |
| East North Central | 1.579 |
| West North Central | 1.746 |
| South Atlantic | 1.342 |
| East South Central | 1.470 |
| West South Central | 1.529 |
| Mountain | 1.542 |
| Pacific Contiguous | 0.435 |
| Pacific Noncontiguous | 1.393 |
| U.S. Average | 1.341 |

Data from “Carbon Dioxide Emissions from the Generation of Electric Power in the United States,” July 2000, Department of Energy, Washington D.C. 20585, Environmental Protection Agency, Washington D.C. 20460.

Accordingly, if consumers are interested in having a more accurate measure of the amount of carbon emitted into the atmosphere by their energy use, they will need to program their energy meter with the geographically-appropriate carbon dioxide emission rate. For customers not interested in such accurate numbers, the device may be programmed with the national average as the default.

To use the device, the consumer plugs the appliance into the sensor portion of the meter. The sensor measures the electricity that is used by the appliance and transmits the data to a central processing unit which then sends the results of calculations to a display to indicate the pounds of carbon that were emitted. To enhance the accuracy of the information presented by the device, it may be equipped with an aging icon that can display how old the reading is. Should the consumer see that the icon indicates that the reading is old, the consumer may wait for the refreshed reading to better understand the his or her electricity use.

In one embodiment, the device may be comprised of multiple sensors which can transmit information regarding multiple appliances to the receiver. The receiver can then present the information for each appliance individually or as an aggregate measure of electricity consumed and carbon emitted.

One embodiment of the invention includes a wireless transmission from the sensor to the receiver. A second embodiment utilizes two components, a sensor and a receiver, that are tethered together by wires for the transmission of information. Yet another embodiment is a unit in which the sensor and receiver are integrated within a single housing, which also includes a display.

### DESCRIPTION OF THE SEVERAL VIEWS OF THE DRAWINGS

FIG. 1A is a representation of a wireless embodiment of the present invention.

FIG. 1B is a circuit block diagram of a wireless embodiment.

FIG. 2A is a circuit block diagram of a tethered embodiment.

FIG. 2B is a representation of a tethered embodiment.

FIG. 3A is a circuit block diagram of an embodiment where the sensor, receiver, and display are integrated into a single housing.

FIG. 3B is a representation of the embodiment with components integrated into a single housing.

### DETAILED DESCRIPTION OF THE INVENTION

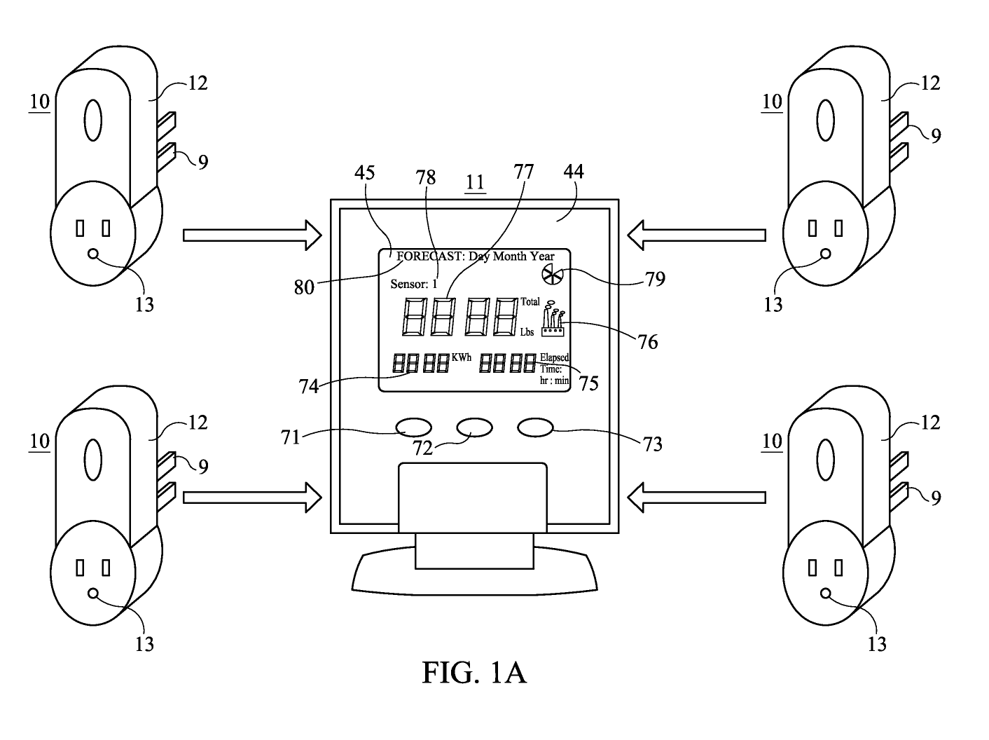

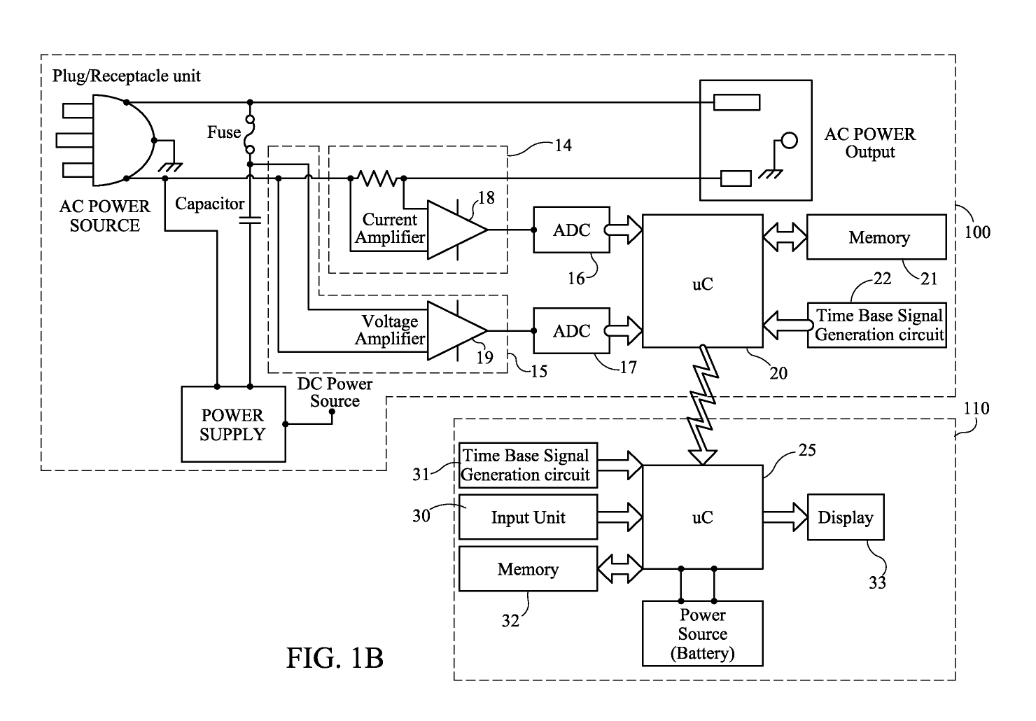

FIG. 1A shows a wireless embodiment of the invention which consists of at least one energy sensor 10 and a display unit 11. Sensor 10 is comprised of a housing 12 which has an outlet 13 formed thereon and an electrical plug 9 extending therefrom. An appliance having an electrical plug, such as e.g., a computer or toaster, is plugged into outlet 13 on housing 12 and sensor 10 is plugged into an electrical socket so that energy consumption of the appliance may be measured. Data relating to the electricity drawn by the appliance is transmitted wirelessly to display unit 11 for processing and display. Display unit 11 may be configured to receive data from multiple sensors and display cumulative data readings, or to display data received from individual sensors for individual appliance display, or to display individual and cumulative readings simultaneously. Display unit 11 may also be configured to display projections of electricity use or cost on user-selectable time periods, such as daily, monthly, or annual basis.

A circuit block diagram of the circuit of the wireless embodiment of the inventive device is shown in FIG. 1B. Circuit 100 is arranged on a circuit board inside sensor 10 and circuit 110 is arranged on a circuit board within display unit 11.

Current sensing circuit 14 and voltage sensing circuit 15 detect and measure the current and voltage levels of the electricity drawn by the appliance. This technology, including the various circuitry choices and components, is known to those skilled in the art. While the embodiments herein incorporate voltage detecting circuits, other configuration in which a constant voltage is programmed into the unit may also be employed. This type of configuration will be less costly to manufacture but will lower the accuracy of the readings.

In a preferred embodiment, analog-to-digital converter 16 converts the analog current signal passing through current amplifier 18 into a digital signal; analog to digital converter 17 converts the analog voltage signal passing through voltage amplifier 19 into a digital signal. These signals are sent to control circuit 20 which also receives, transmits to, and processes data stored in memory 21 as well as data from time base signal generation circuit 22.

Control circuit 20 wirelessly transmits data relating to the current, voltage, phase angle, power, consumption since last transmission, and accumulated consumption to the control circuit 25 where it is further processed and the resulting data is stored in memory 32.

In setting up the inventive device for use, the user will obtain the carbon dioxide emission rate for the relevant geographic region and program that rate into the device using input unit 30; this data is sent to control circuit 25. Other data, such as cost of electricity per kilowatt-hour, can also be obtained locally and entered into the system using input unit 30. Control circuit 25 processes the data received from control circuit 20 with the data input by the user as well as data received from time base signal generation circuit 31 and memory 32 to calculate, inter alia, a value for the amount of carbon dioxide that was emitted into the atmosphere by the generation of the amount of electricity used by the appliance. Control circuit 25 sends that carbon amount value, as well as other data, to display 33.

The front panel 44 of display 33, shown in FIG. 1A includes a screen 45, such as an LED or LCD display, that indicates information such as the cost of electricity consumed, the number of the monitored sensor, and physical data such as voltage, current, kilowatt-hour, carbon emitted, elapsed time, evaluation period, aging icon, and low battery indicator. Input and selection devices, such as buttons 71, 72, and 73, are configured to input data through input unit 30 to control circuit 25 and to cycle the display through different values, e.g., to estimate future costs for different evaluation periods, to show different measured or calculated values of one sensor, to show cumulative values of multiple sensors, or to change the display to a different sensor or an auto-display function. The display unit can show the data received from an individual sensor 10 and an indication 78 on screen 45 will specify from which of the multiple sensors 10 the data is being drawn.

Information relating to electricity drawn by the appliance can be shown on the screen in various configurations, one of which is shown in FIG. 1A, where the total amount of pounds of carbon emissions is shown as a primary value 77, and measured kilowatt-hours and elapsed time of measurement are shown as secondary values 74 and 75.

The system is continually reading the current and voltage, storing the values in memory 21 and memory 32, while control circuit 20 processes the values and sends data to control circuit 25 which sends processed data to display unit 11. While the display may be configured to show data in real time, in certain instances it may be more cost-effective to display periodic readings. To reflect that the data displayed is not in real time, but rather is being refreshed periodically, display screen 45 may be configured with an aging icon, such as the pie chart icon 79 as shown in FIG. 1A, to indicate whether the reading is fresh (no pie sections) or old (full pie icon).

Screen 45 may contain other icons, such as a coal plant icon 76 to indicate carbon emissions, used to clarify or emphasize the type of value on display.

The device may be programmed to display projections of usage based on prior usage. Projections can be shown as the primary value 77 with an indicator 80 showing whether the projection is a daily, weekly, monthly, or yearly forecast.

Data may be sent from a number of different sensors, as shown in FIG. 1A, and data may be displayed individually from each sensor for a measure of the usage of one appliance, or cumulatively, e.g., measuring and adding together all the components on a home entertainment center.

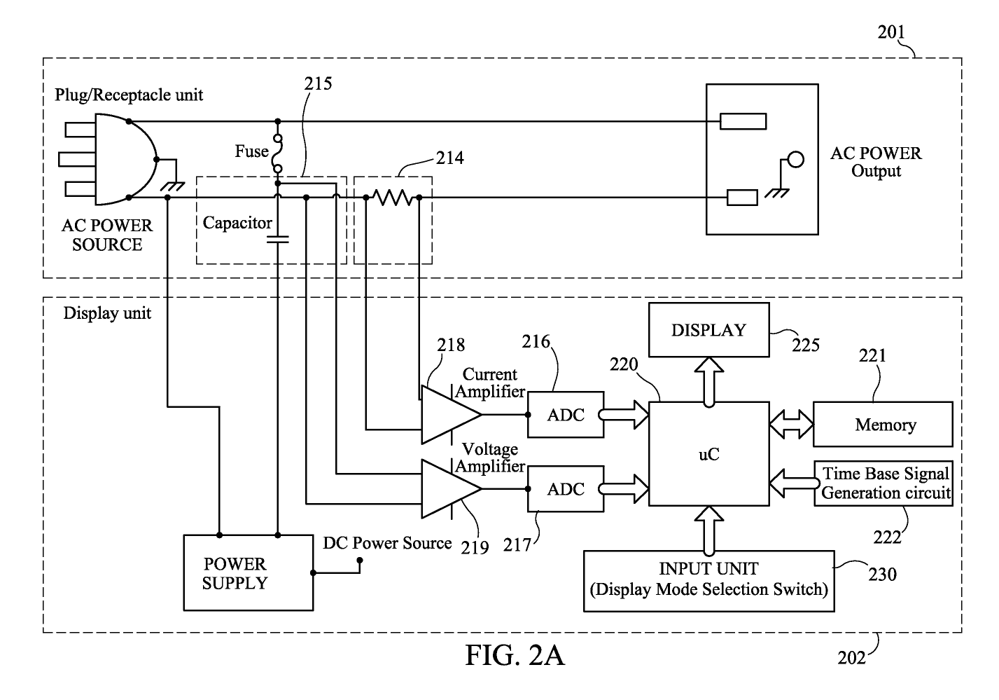

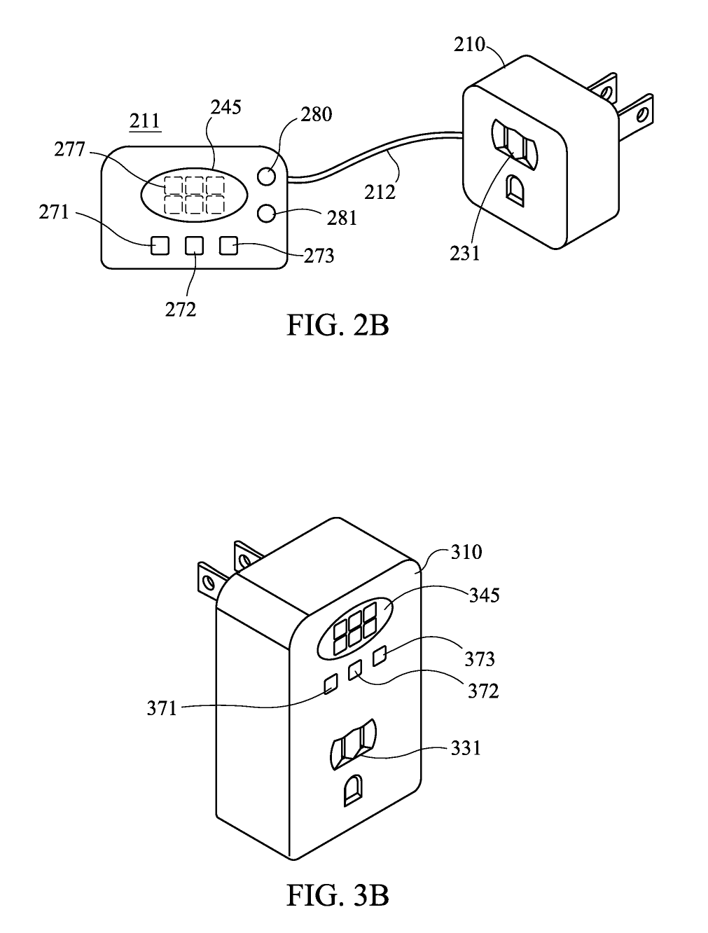

FIG. 2A shows a circuit board diagram of a second embodiment of the present invention where the components, sensor 210 and display unit 211, shown in FIG. 2B, are tethered by a wire 212. An appliance is plugged into outlet 231 on sensor 210. Sensor 210 gathers the voltage and current signals drawn by the appliance, and transmits those signals, through wire 212 to display unit 211.

Circuit 201 is arranged on a circuit board inside energy sensor 210 and circuit 202 is arranged on a circuit board within display unit 211. Current sensing circuit 214 and voltage sensing circuit 215 detect and measure the current and operating voltage level, respectively, of the electricity drawn by the appliance.

In this preferred embodiment, analog-to-digital converter 216 converts the analog current signal passing through current amplifier 218 into a digital signal; analog to digital converter 217 converts the analog voltage signal passing through voltage amplifier 219 into a digital signal. These signals are sent to control circuit 220 which, in addition, receives, transmits, and processes data stored in memory 221 as well as data from time base signal generation circuit 222.

Control circuit 220 then sends data relating to the current, voltage, phase angle, power, consumption since last transmission, and accumulated consumption through the circuit to the display 225.

In setting up the inventive device for use, the user will obtain the carbon dioxide emission rate for the relevant geographic region and program that rate into the device using input and selection devices, buttons 271, 272, and 273 shown in FIG. 2B, to input unit 230 which then will be sent to control circuit 220. Other data, such as cost of electricity per kilowatt-hour, can also be obtained locally and entered into the system using input devices 271, 272, and 273, to input unit 230. Control circuit 220 processes the data received from voltage detecting circuit 215 and current detecting circuit 214 with the data input by the user as well as data received from time base signal generation circuit 222 and memory 221 to calculate, inter alia, a value for the amount of carbon dioxide that was emitted into the atmosphere by the generation of the amount of electricity used by the appliance. Control circuit 220 then sends that carbon amount value to display 225.

The front panel of display 211, shown in FIG. 2B includes a screen 245, such as an LED or LCD display, that indicates information such as the cost of electricity consumed, physical data such as voltage, current, kilowatt-hour, carbon emitted, elapsed time, and evaluation period. Buttons 271, 272, and 273 can be configured to cycle the display through different values, e.g., to estimate future costs for different evaluation periods or to change the display to different parameters. Information relating to electricity drawn by the appliance can be shown on the screen in various configurations, such as total weight of carbon emitted, kilowatt-hours, cost, projected use or cost, etc., shown as a primary value 277.

The system is continually reading the current and voltage, storing the values in memory 221, while control circuit 220 processes the data and sends processed data to display unit 211.

Screen 245 may contain other icons 281 to emphasize the type of value on display, such as a coal image, dollar sign, or electricity symbol.

The device may be programmed to display projections of usage based on prior usage. Projections can be shown as the primary value 277 with a further icon 280 showing whether the projection is a daily, weekly, monthly, or yearly forecast.

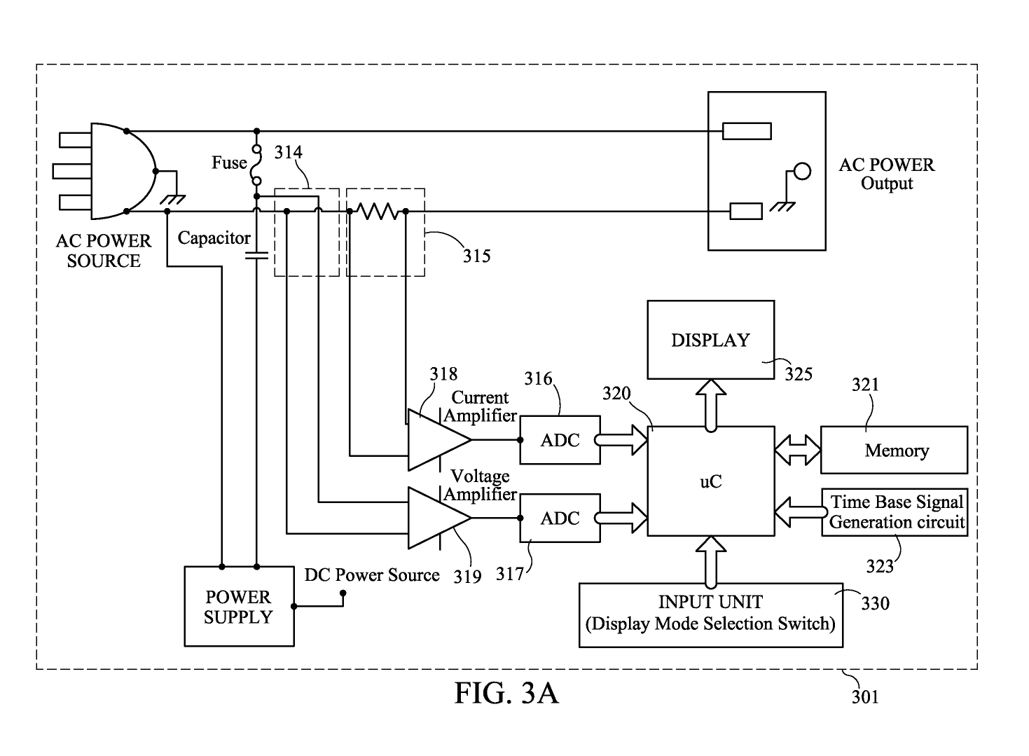

FIG. 3A shows circuit board 301 of a further embodiment of the present invention where the sensors and display unit are contained within the same housing 310, shown in FIG. 3B. An appliance is plugged into outlet 331 on housing 310. During operation of the appliance, voltage detecting circuit 314 and current detecting circuit 315 detect and measure the current and operating voltage, respectively, of the electricity drawn by the appliance. This technology, including the various circuitry choices and components, is known to those skilled in the art.

In a preferred embodiment, analog-to-digital converter 316 converts the analog current signal passing through current amplifier 318 into a digital signal; analog to digital converter 317 converts the analog voltage signal passing through voltage amplifier 319 into a digital signal. These signals are sent to control circuit 320 which, in addition, receives, transmits, and processes data stored in memory 321 as well as data from time base signal generation circuit 323.

Control circuit 320 then sends data relating to the current, voltage, phase angle, power, consumption since last transmission, and accumulated consumption through the circuit to the display 325.

In setting up the inventive device for use, the user will obtain the carbon dioxide emission rate for the relevant geographic region and program that rate into the device using input and selection devices 371, 372, 373 to input unit 330 which then will be sent to control circuit 320. Other data, such as cost of electricity per kilowatt-hour, can also be obtained locally and entered into the system using input devices 371, 372, 373. Control circuit 320 processes the data received from voltage detecting circuit 314 and current detecting circuit 315 with the data input by the user as well as data received from time base signal generation circuit 323 and memory 321 to calculate, inter alia, a value for the amount of carbon dioxide that was emitted into the atmosphere by the generation of the amount of electricity used by the appliance. Control circuit 320 then sends that carbon amount value to display 325.

Housing 310 includes a screen 345, such as an LED or LCD display, that indicates information such as the cost of electricity consumed, physical data such as voltage, current, kilowatt-hour, carbon emitted, elapsed time, and evaluation period. Buttons 371, 372, and 373 may be configured to cycle the display through different values, e.g., to estimate future costs for different evaluation periods or to change the display to indicate different parameters. Information relating to electricity drawn by the appliance can be shown on the screen in various configurations, such as total weight of carbon emitted, kilowatt-hours, cost, projected use or cost, etc.

The system is continually reading the current and voltage, storing the values in memory 321, while control circuit 325 processes the data and sends processed data to display screen 345. Screen 345 may contain other icons to emphasize the type of value on display, such as a coal image, dollar sign, or electricity symbol.

The device may be programmed to display projections of usage based on prior usage. Projections can be shown as the primary value 377 with other icons showing whether the projection is a daily, weekly, monthly, or yearly forecast.

1. An energy monitor comprising:
a. at least one sensor housing comprising an electrical receptacle thereon and an electrical plug extending therefrom, and a current sensor, a first control circuit, and a wireless transmitting device therein; where the sensor housing can be plugged into an electrical outlet and an appliance may be plugged into the electrical receptacle, and where the electrical receptacle is operatively connected to the electrical outlet such that the appliance draws electricity, and where the current sensor detects the amount of current drawn by the appliance and transmits the amount of current as a current value to the first control circuit which processes the current value into calculated values including the amount of electricity consumed, which calculated values are then transmitted by the wireless transmitting device;
b. a display housing comprising a display screen thereon, a receiving device and second control circuit therein; wherein the receiving device receives the calculated values and wherein the second control circuit multiplies the amount of electricity consumed by an emission rate factor to calculate a carbon value for an amount of carbon that was emitted during production of the amount of electricity consumed and sends the carbon value to the display screen.

2. An energy monitor according to claim 1 wherein the sensor housing further comprises a voltage sensor which detects an operating voltage level and transmits the voltage level to the first control circuit which processes the voltage level into the calculated values.

3. An energy monitor according to claim 1 wherein the display housing further comprises an input unit connected to the second control circuit which can be used to program the second control circuit with a geographically specific emission rate factor.

4. An energy monitor according to claim 1 further comprising a plurality of sensor housings.

5. An energy monitor according to claim 1 wherein the display screen may display at least a first icon indicating a type of value displayed.

6. An energy monitor according to claim 1 wherein a second icon indicates the age of the value displayed.

7. An energy monitor according to claim 1 wherein the display indicates projections of electricity use based on prior electricity use.

8. An energy monitor comprising:
a. a sensor housing comprising an electrical receptacle thereon and an electrical plug extending therefrom, and a current sensor;
b. a display housing comprising a display screen thereon, and a control circuit therein;
where the sensor housing can be plugged into an electrical outlet and an appliance may be plugged into the electrical receptacle, and where the electrical receptacle is operatively connected to the electrical outlet such that the appliance draws electricity, and where the current sensor detects the amount of current drawn by the appliance, and transmits the amount of current as a current value through a set of wires to the control circuit which processes the current value into calculated values including the amount of electricity consumed; and wherein the control circuit multiplies the amount of electricity consumed by an emission rate factor to calculate a carbon value for an amount of carbon that was emitted during production of the amount of electricity consumed and sends the carbon value to the display screen.

9. An energy monitor according to claim 8 wherein the sensor housing further comprises a voltage sensor which detects an operating voltage level and transmits the voltage level to the control circuit which processes the voltage level into the calculated values.

10. An energy monitor according to claim 8 wherein the display housing further comprises an input unit connected to the control circuit which can be used to program the control circuit with a geographically specific emission rate factor.

11. An energy monitor according to claim 8 wherein the display screen may display at least a first icon indicating a type of value displayed.

12. An energy monitor according to claim 11 wherein a second icon indicates the age of the value displayed.

13. An energy monitor comprising:
a housing comprising an electrical receptacle thereon and an electrical plug extending therefrom, and containing a current sensor, a display screen thereon, a control circuit therein;
where the housing can be plugged into an electrical outlet and an appliance may be plugged into the electrical receptacle, and where the electrical receptacle is operatively connected to the electrical outlet such that the appliance draws electricity, and where the current sensor detects the amount of current drawn by the appliance and transmits the amount of current as a current value to the control circuit which processes the current value into calculated values including the amount of electricity consumed, and wherein the control circuit multiplies the amount of electricity consumed by an emission rate factor to calculate a carbon value for an amount of carbon that was emitted during production of the amount of electricity consumed and sends the carbon value to the display screen.

14. An energy monitor according to claim 13 wherein the housing further comprises a voltage sensor which detects an operating voltage level and transmits the voltage level to the control circuit which processes the voltage level into the calculated values.

15. An energy monitor according to claim 13 wherein the housing further comprises an input unit connected to the control circuit which can be used to program the control circuit with a geographically specific emission rate factor.

16. An energy monitor according to claim 13 wherein at least a first icon indicates the age of the value displayed.
